(19) United States
(12) Patent Application Publication
(10) Pub. No.: US 2026/0078857 A1
(43) Pub. Date: Mar. 19, 2026

(54) PIPE COUPLING CONFIGURATIONS

(71) Applicant: 2316354 AB, Ltd., Edmonton (CA)

(72) Inventor: Terrence Michael Dirk, Edmonton (CA)

(73) Assignee: 2316354 AB, Ltd., Edmonton (CA)

(21) Appl. No.: 19/330,742

(22) Filed: Sep. 16, 2025

Related U.S. Application Data
(60) Provisional application No. 63/695,832, filed on Sep. 17, 2024.
(60) Provisional application No. 63/733,843, filed on Dec. 13, 2024.

(51) Int. Cl. F16L 47/14

(52) U.S. Cl. CPC F16L 47/14

(57) ABSTRACT

The present disclosure discloses pipe coupling configurations including a plastic pipe coupler for coupling plastic pipe segments. The pipe coupler includes tubular hubs connected to the pipe segments, the tubular hubs being arranged in a mirrored arrangement such that a predesigned gap separates the tubular hubs; an annular rubberized gasket configured to hold the first tubular hub and the second tubular hub in the mirrored arrangement, the rubberized gasket including a protrusion that touches each of the tubular hubs to wholly cover the gap, such that leakage of a liquid, that is being transported via the pipe segments, through the gap is mitigated; and a clamping ring configured to annularly extend over the rubberized gasket and the tubular hubs to seal the mirrored arrangement and to couple the pipe segments. Various other aspects are contemplated.

### FIELD OF DISCLOSURE

Aspects of the present disclosure generally relate to configurations for coupling pipe segments, and more particularly to devices, assemblies, and methods for coupling plastic pipe segments in a fluid-tight manner.

### BACKGROUND

Pipelines are widely used across industries such as water distribution, wastewater management, oil and gas transport, chemical processing, and the like. To construct the pipelines, multiple pipe segments may be connected end-to-end to form a continuous pipeline conduit. Achieving a durable and leak-free joint between connected pipe segments is critical to ensure system reliability, safety, and efficiency.

### SUMMARY

In one aspect, the present disclosure contemplates a plastic pipe coupler system for coupling plastic pipe segments. The plastic pipe coupler system comprises a first tubular hub connected to a first pipe segment and a second tubular hub connected to a second pipe segment, the first tubular hub and the second tubular hub being arranged in a mirrored arrangement such that a predesigned gap separates the first tubular hub and the second tubular hub; an annular rubberized gasket configured to hold the first tubular hub and the second tubular hub in the mirrored arrangement, the rubberized gasket including a protrusion that touches each of the first tubular hub and the second tubular hub to wholly cover the gap, such that leakage of a liquid, that is being transported via the pipe segments, through the gap is mitigated; and a clamping ring configured to annularly extend over the rubberized gasket, the first tubular hub, and the second tubular hub to seal the mirrored arrangement and to couple the pipe segments.

In one aspect, the present disclosure contemplates a coupling method for utilizing a pipe coupler to couple plastic pipe segments. The coupling method includes connecting a first tubular hub to a first pipe segment and a second tubular hub to a second pipe segment, the first tubular hub and the second tubular hub being arranged in a mirrored arrangement such that a predesigned gap separates the first tubular hub and the second tubular hub; utilizing a rubberized gasket to hold the first tubular hub and the second tubular hub in the mirrored arrangement, the rubberized gasket including a protrusion that touches each of the first tubular hub and the second tubular hub to wholly cover the gap, such that leakage of a liquid, that is being transported via the pipe segments, through the gap is mitigated; and utilizing a clamping ring to annularly extend over the rubberized gasket, the first tubular hub, and the second tubular hub to seal the mirrored arrangement and to couple the pipe segments.

In another aspect, the present disclosure contemplates means for coupling pipe segments. Such means include means for connecting a first tubular hub to a first pipe segment and a second tubular hub to a second pipe segment, the first tubular hub and the second tubular hub being arranged in a mirrored arrangement such that a predesigned gap separates the first tubular hub and the second tubular hub; a rubberized gasket for holding the first tubular hub and the second tubular hub in the mirrored arrangement, the rubberized gasket including a protrusion that touches each of the first tubular hub and the second tubular hub to wholly cover the gap, such that leakage of a liquid, that is being transported via the pipe segments, through the gap is mitigated; and a clamping ring to annularly extend over the rubberized gasket, the first tubular hub, and the second tubular hub to seal the mirrored arrangement and to couple the pipe segments.

It is to be understood that both the foregoing general description and the following detailed description are exemplary and explanatory in nature and are intended to provide an understanding of the present disclosure without limiting the scope thereof. In that regard, additional aspects, features, and advantages of the present disclosure will be apparent to one skilled in the art from the following detailed description.

### BRIEF DESCRIPTION OF THE DRAWINGS

The accompanying drawings illustrate aspects of systems, devices, methods, and/or mediums disclosed herein and together with the description, serve to explain the principles of the present disclosure. Throughout this description, like elements, in whatever aspect described, refer to common elements wherever referred to and referenced by the same reference number. The characteristics, attributes, functions, interrelations ascribed to a particular element in one location apply to those elements when referred to by the same reference number in another location unless specifically stated otherwise.

The figures referenced below are drawn for ease of explanation of the basic teachings of the present disclosure; the extensions of the figures with respect to number, position, relationship, and dimensions of the parts to form the following aspects may be explained or may be within the skill of the art after the following description has been read and understood. Further, exact dimensions and dimensional proportions to conform to specific force, weight, strength, and similar requirements will likewise be within the skill of the art after the following description has been read and understood.

The following is a brief description of each figure used to describe the present disclosure, and thus, is being presented for illustrative purposes only and should not be limitative of the scope of the present disclosure.

FIG. 1 is an illustration of an example system 100 associated with pipe coupling configurations, according to various aspects of the present disclosure.

FIG. 2 is an illustration of components of an example system 100 associated with pipe coupling configurations, according to various aspects of the present disclosure.

FIGS. 3A-3C are illustrations of example configurations 300 associated with pipe coupling configurations, according to various aspects of the present disclosure.

FIG. 4 is an illustration of example process associated with pipe coupling configurations, according to various aspects of the present disclosure.

### DETAILED DESCRIPTION

For the purposes of promoting an understanding of the principles of the present disclosure, reference will now be made to the aspects illustrated in the drawings, and specific language may be used to describe the same. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or steps described with respect to one aspect may be combined with the features, components, and/or steps described with respect to other aspects of the present disclosure. For the sake of brevity, however, the numerous iterations of these combinations may not be described separately. For simplicity, in some instances the same reference numbers are used throughout the drawings to refer to the same or like parts.

Pipe segments are commonly connected through a variety of means, including welding or couplers. When a pipeline is utilized for transport of abrasive and/or non-abrasive items (e.g., water, compressed air, natural gas, chemical solutions in liquid form, etc.), the pipe segments may be formed of plastic material such as, for example, including high density polyethylene (HDPE) or other suitable plastics. Multiple methods for connecting such plastic pipe segments have been proposed, with butt welding and electrofusion being most commonly employed for endwise coupling.

Butt welding and electrofusion provide permanent connection of plastic pipes and may rely heavily on a skill of an operator to achieve satisfactory results. Also, permanently connected pipe segments may not capable of being disassembled for maintenance, inspection, reuse, or reconfiguration, which undesirably limits flexibility in pipeline operation, prevents cost-effective replacement of damaged pipe segments, and requires specialized equipment and operator training for installation. A permanently connected joint may be separated by cutting the pipe, which results in material waste, additional labor, and downtime of the pipeline system, thereby reducing overall operational efficiency. As a result, entities responsible for managing pipelines may expend human, financial, and operational resources to manage plastic pipe segments joined by butt welding. For these reasons, permanent connections of pipe segments may be less preferred.

Metal couplers are also currently used for coupling plastic pipe segments. The metal couplers provide a rigid metallic housing that receives opposed pipe segment ends and secures them in place, often with the aid of compression rings and/or threaded fasteners (e.g., screws), which undesirably cut grooves or indentations into a surface (outer or inner) of a pipe segment and compromising an integrity of the pipe segment. Such metal couplers are valued for their strength, but may increase material costs and add heavy weight to the pipeline, such that the heavy weight may carry an injury risk during handling or installation/removal. Components including metallic parts may undesirably rust when exposed to moisture and oxygen or other corrosive pipeline fluids, leading to surface degradation and eventual weakening of the pipe coupler and/or the pipeline. Such rusting or corrosion not only reduces structural integrity but can also contaminate the fluid being transported. Metal couplers may also introduce compatibility and/or fitment challenges due to differences in thermal expansion between the metal coupler and the plastic pipe segments. This is because metal and plastic expand and contract at different rates when exposed to temperature changes. For instance, when a plastic pipeline is subjected to heating or cooling cycles, the plastic pipe segments may expand and contract to a greater extent and at a faster rate than the metal couplers. This mismatch in dimensional changes places stress on the joint, reduces the effectiveness of the seal, and causes deterioration or breakage in the plastic material, thereby resulting in mechanical failure and/or leakage. As a result, long-term reliability of utilizing a metal coupler to couple plastic pipe segments may be compromised, particularly in applications where pipelines are exposed to varying temperatures. Constant inspection of such couplings may also be required.

As a result, entities responsible for managing pipelines coupled using metal couplers may inefficiently expend human, financial, and operational resources due to the need for frequent inspection, maintenance, and replacement of the plastic pipe segments. The stress on joints caused by differences in thermal expansion, combined with potential deterioration of the plastic pipe segments from compression rings or threaded fasteners, can lead to leaks or mechanical failure, resulting in increased labor, material costs, and operational downtime. For these reasons, metal couplers may be less preferred.

Various aspects of systems and techniques discussed in the present disclosure provide pipe coupling configurations. In some aspects, a proposed configuration a pipe coupler includes two circular hollow hubs for coupling plastic pipe segments. The two hubs are made of plastic and are positioned in a mirrored arrangement with respect to each other such that a predetermined amount of space (e.g., gap) separates the two hubs. Each hub contains a flange and a sleeve. In some aspects, the flange extends radially outwards (e.g., vertically) with respect to a longitudinal axis passing through the pipe segments and the sleeve extends horizontally with respect to the longitudinal axis. In some aspects, an amount of height of the flanges in the radially outward direction may be determined based at least in part on a diameter of the pipe segments. In the mirrored arrangement, an area formed between a first flange of a first hub and a second flange of a second hub is configured to accept an annular rubberized gasket such that a first portion (e.g., first half) of the rubberized gasket rests on a first sleeve of the first hub and a second portion (e.g., second half) of the rubberized gasket rests on a second sleeve of the second hub. In some aspects, the rubberized gasket serves to tightly hold the sleeves in position in the mirrored arrangement and to seal openings around the sleeves in a fluid-tight manner. In some aspects, the rubberized gasket may include hollow spaces to allow the rubberized gasket to expand when pressurized by a liquid flowing through the pipe segments, the expanding serving to seal seams (e.g., openings) in the mirrored arrangement. Each pipe segment to be coupled is fused (e.g., butt welded) to the respective hub. In an example, a first pipe segment is fused to a first hub and a second pipe segment is fused to a second hub, wherein the first pipe segment and the second pipe segment are to be coupled by the pipe coupler. The pipe coupler also includes a clamping ring made of plastic and configured to be placed such that the clamping ring extends to cover the first flange and the second flange to apply compressive forces thereto, thereby holding the hubs in the mirrored arrangement to form a fluid-tight seal. In some aspects, because the clamping ring is also made of plastic, the amount of height of the flanges can be increased to enable the clamping ring to cover a larger surface area of the flanges, thereby enabling a more robust and reliable seal, without damaging the pipe coupler or the pipe segments. By simply removing the clamping ring, pipe segments coupled using the proposed pipe coupler may easily be disassembled for maintenance, inspection, reuse, or reconfiguration with no damage to the pipe segments. As such, material waste, need for additional labor, and any downtime may be mitigated. Further, because the pipe coupler is also made of plastic, concerns related to use of metal couplers such as deteriorating bodies of pipe segments (e.g., rust corrosion, grooves, threads, etc.) are mitigated. Moreover, components of the pipe coupler and the pipe segments expand and contract to similar extents and at similar rates such that there is a minimal mismatch in dimensional changes, thereby increasing an effectiveness of the seal without causing deterioration or breakage in the plastic material. Constant inspection of such couplings may also be avoided. In this way, by utilizing the proposed pipe coupler, entities may efficiently expend human, financial, and operational resources while managing pipelines.

In some aspects, a plastic pipe coupler that is configured to couple plastic pipe segments comprises: a first tubular hub connected to a first pipe segment and a second tubular hub connected to a second pipe segment, the first tubular hub and the second tubular hub being arranged in a mirrored arrangement such that a predesigned gap separates the first tubular hub and the second tubular hub; an annular rubberized gasket configured to hold the first tubular hub and the second tubular hub in the mirrored arrangement, the rubberized gasket including a protrusion that touches each of the first tubular hub and the second tubular hub to wholly cover the gap, such that leakage of a liquid, that is being transported via the pipe segments, through the gap is mitigated; and a clamping ring configured to annularly extend over the rubberized gasket, the first tubular hub, and the second tubular hub to seal the mirrored arrangement and to couple the pipe segments.

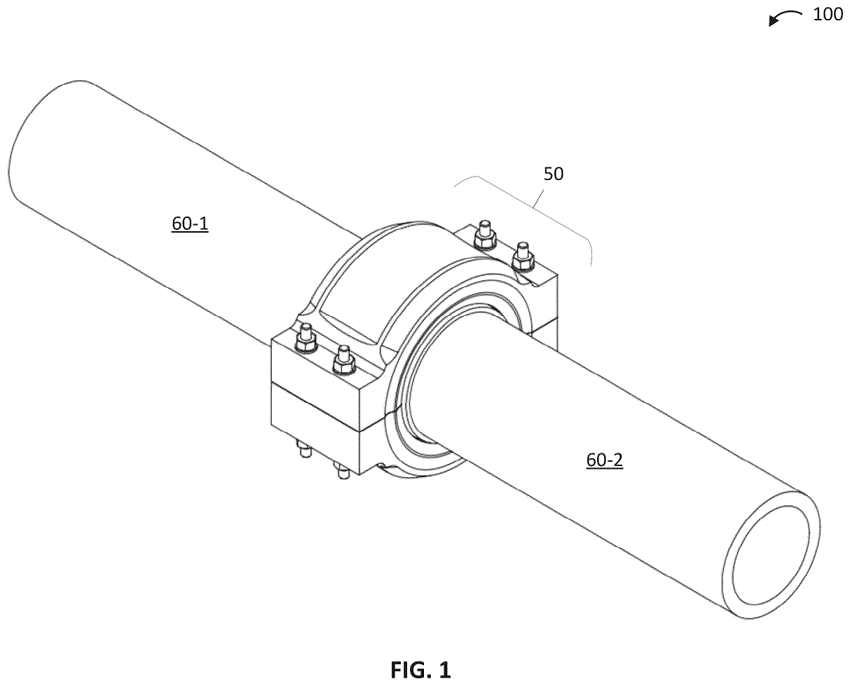

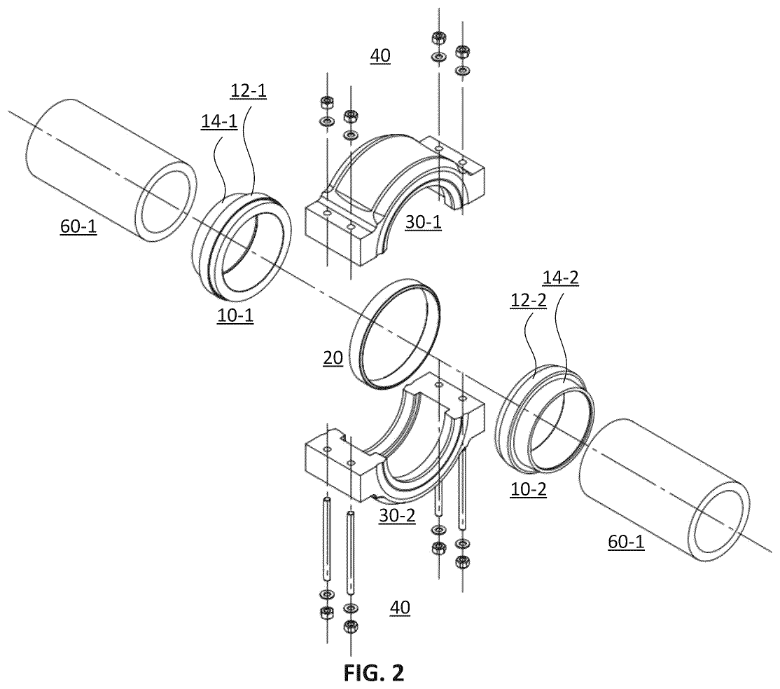

FIG. 1 is an illustration of an example system 100 associated with pipe coupling configurations, according to various aspects of the present disclosure. The system 100 includes a pipe coupler 50 that end-wise couples (e.g., connects) two separate plastic pipe segments 60-1, 60-2 to form a fluid-tight pipeline. As shown in FIG. 2, in some aspects, the pipe coupler 50 may include two tubular hubs 10-1, 10-2, an annular rubberized gasket 20, and a clamping ring 30 (including a top component 30-1 and a bottom component 30-2) fastened by utilizing nut/bolts/screws 40.

In some aspects, the pipe segments 60-1, 60-2 may be made of plastic. Further, one or more components of the pipe coupler 50, namely the tubular hubs 10-1, 10-2 and the clamping ring 30 may be made of plastic. As a result, system 100 benefits from a uniformity of material properties that directly improves long-term performance and reliability. One significant advantage is the uniform coefficient of thermal expansion/contraction across all components. Because the pipe segments 60-1, 60-2, tubular hubs 10-1, 10-2, and clamping ring 30 expand and contract at similar rates and to similar extents during temperature changes, differential stresses that often arise at joints between dissimilar materials (e.g., metal and plastic) are substantially mitigated. This uniform expansion and contraction minimizes a risk associated with leaks, material fatigue, or crack initiation, thereby enhancing the integrity of the coupling over a wide range of temperature and operating conditions.

Another advantage of using plastic throughout is the reduced mechanical stress at physical contact points. When metal parts are pressed against plastic pipe segments, localized stresses can arise due to differences in stiffness and hardness, potentially leading to deformation or wear of the plastic surface over time. By contrast, when the contacting surfaces are all plastic, as proposed herein, the stresses are distributed more evenly across the contact area, resulting in lower peak stresses and reduced likelihood of gouging, scoring, or creep at the interfaces. This more uniform load transfer is especially valuable in pressurized systems, where maintaining gasket compression and joint tightness is essential.

Additionally, plastic components are lighter than their metal counterparts, making installation simpler and safer while reducing the overall structural load on supports and/or hangers. Plastic parts offer inherent corrosion resistance, eliminating concerns about galvanic corrosion that may otherwise occur at interfaces between metal and plastic parts, especially in humid or chemically aggressive environments. This resistance extends the service life of the system 100 and reduces a need for protective coatings or frequent maintenance. Together, these advantages make an all-plastic assembly particularly well-suited for fluid transport systems that must remain reliable, leak-free, and durable while being economical to produce and safer to install.

The pipe segments 60-1, 60-2, the tubular hubs 10-1, 10-2, and/or the clamping ring 30 may each be formed from any combination of a wide variety of plastic materials. High-density polyethylene (HDPE) is one suitable material because it provides toughness, flexibility, and strong resistance to impact. HDPE is chemically resistant and resistant to corrosion when exposed to soil or water, making it effective for use in both underground and above-ground pipelines. HDPE's ability to tolerate thermal expansion and contraction without developing high stresses makes it particularly well-suited for coupler assemblies where tight seals are to be maintained over time.

Polyvinyl chloride (PVC) is another option that may be used to form any of the pipe segments 60-1, 60-2, the tubular hubs 10-1, 10-2, and/or the clamping ring 30. PVC is lightweight, rigid, and cost-effective, with broad resistance to acids, bases, and salts. PVC's rigidity can provide dimensional stability for the pipe segments 60-1, 60-2, while also ensuring reliable performance for the tubular hubs 10-1, 10-2 and/or the clamping ring 30. PVC has a lower thermal expansion rate than some other plastics, which may help reduce stresses between the mating parts of the coupler assembly.

Fiberglass-reinforced plastics may also be employed to form any of the pipe segments 60-1, 60-2, the tubular hubs 10-1, 10-2, and/or the clamping rings 30. Fiberglass provides a composite structure in which glass fibers are embedded in a polymer matrix, resulting in components that are lightweight but strong. This reinforcement improves resistance to both compressive and tensile loads, which can be advantageous for the clamping rings 30 and the hubs 10-1, 10-2 where compressive sealing forces are applied. The same fiberglass reinforcement can also be used in the pipe segments 60-1, 60-2 to provide higher structural strength while maintaining corrosion resistance.

Composites made of thermoplastics blended with reinforcing fibers or mineral fillers represent yet another suitable class of materials for the pipe segments 60-1, 60-2, the tubular hubs 10-1, 10-2, and/or the clamping rings 30. Such composites may be engineered to provide a specific balance of stiffness, toughness, and thermal stability. For example, carbon-fiber-reinforced thermoplastics may be used to increase load-bearing capacity of the clamping rings 30, while mineral-filled composites may be applied to the pipe segments 60-1, 60-2 and/or the hubs 10-1, 10-2 to provide dimensional stability under pressure. In all cases, the use of composites allows the properties of the coupler components to be tuned for the demands of the pipeline environment. Any of the above plastic materials (HDPE, PVC, fiberglass-reinforced plastics, or composites) may be used alone or in combination with one another to form the pipe segments, tubular hubs, or clamping rings.

Each tubular hub 10-1, 10-2 may respectively include (i) a flange that extends radially outwards (e.g., vertically) with respect to a longitudinal axis passing through the pipe segments 60-1, 60-2 and (ii) a sleeve that extends horizontally with respect to the longitudinal axis. For instance, a first tubular hub 10-1 includes a first flange 12-1 and a first sleeve 14-1, and a second tubular hub 10-2 includes a second flange 12-2 and a second sleeve 14-2.

As discussed above, flanges 12-1, 12-2 may extend radially outward in a generally vertical direction relative to a longitudinal axis and sleeves 14-1, 14-2 may extend horizontally with respect to the longitudinal axis. An amount of radial extension of the flange (e.g., flange height)—that is, the extent to which the flange extends outwardly—may be predetermined based at least in part on a diameter of the pipe segments 60-1, 60-2. The flange height is critical because it enables the clamping ring 30 to cover a larger surface area of the flanges, thereby enabling a more robust and reliable seal, without damaging the pipe coupler or the pipe segments

In some aspects, the flange height may be determined in relation to the diameter of the pipe segment 60-1, 60-2 so as to maximize the surface area of contact between the flange 12-1, 12-2 and the clamping ring 30. The available annular contact area between the flange 12-1, 12-2 and the clamping ring 30 can be expressed as πDh, where D is the diameter of the pipe segments and h is the flange height. A clamping force applied over this contact area may generate an average compressive stress on the flange surface. To maintain the compressive stress at or below an allowable level for the selected flange plastic material, the flange height may be derived according to an example relationship h=F/(πDσ_{allow}), where F is the clamping force and [symbol] _{allow} is a maximum permissible contact stress value associated with the plastic utilized to for the flanges 12-1, 12-2.

By deriving the flange height as a function of the diameter of the pipe segments 60-1, 60-2 and allowable stress, and by implementing reinforcement or load distribution features where necessary, the flange height may be maximized to increase the effective contact surface area over which the clamping ring 30 applies compressive force. This results in a structurally stronger compressive force and a more secure, fluid-tight joint across a range of pipe diameters, without damaging components of the pipe coupler 50 or the pipe segments 60-1, 60-2.

In some aspects, for pipe segments having relatively smaller diameters, the flange height can be relatively short because sufficient sealing and clamping surface area can be achieved with a shorter outward extension. Conversely, for pipe segments having relatively larger diameters, the flange height may be increased proportionally to ensure adequate surface engagement, structural rigidity, and load distribution during clamping. Thus, the flange height can scale with pipe diameter to balance mechanical strength, sealing effectiveness, and manufacturability.

The tubular hubs 10-1, 10-2 may be arranged in a mirrored configuration with the first sleeve 14-1 of the first tubular hub 10-1 facing the second sleeve 14-2 of the second tubular hub 10-2. In some aspects, a predetermined gap (e.g., 1 mm-3 mm) may be designed to separate the first sleeve 14-1 and the second sleeve 14-2. This gap is critical for several reasons. The gap may allow for controlled tolerance during manufacturing and assembly of the tubular hubs 10-1, 10-2, making it easier to align and join pipe segments 60-1, 60-2 without forcing end-to-end contact between the tubular hubs 10-1, 10-2 and/or the pipe segments 60-1, 60-2. Also, the gap may accommodate slight thermal expansion or contraction of the pipe segments 60-1, 60-2 during operation, thereby reducing a risk of compressive stresses or deformation. Further, the gap may provide a defined space for a sealing element (e.g., gasket extension piece) to fill, thereby enhancing fluid-tightness of the connection.

In the mirrored arrangement, a space formed between the extended portion of the first flange 12-1 and the second flange 12-2 is configured to accept the annular rubberized gasket 20 such that a first portion (e.g., less than half, half, or more than half) of the rubberized gasket rests on the first sleeve 14-1 and a second portion (e.g., more than half, half, or less than half) of the rubberized gasket 20 rests on the second sleeve 14-2. In some aspects, the rubberized gasket serves to tightly hold the sleeves 14-1, 14-2 in position in the mirrored arrangement and to seal openings around the sleeves 14-1, 14-2 in a fluid-tight manner.

In some aspects, the rubberized gasket 20 may include one or more hollow spaces 24 that extend along the rubberized gasket 20. When liquid enters such one or more hollow spaces 24, the liquid may pressurize the rubberized gasket 20. As the rubberized gasket 20 gets pressurized, the rubberized gasket 20 may expand radially and axially to engage with (e.g., push against) adjoining surfaces (e.g., flanges, sleeves, clamping ring) of the pipe coupler 50 components and the pipe segments 60-1, 60-2. In an example, pressurization of the rubberized gasket 20 by the liquid from within the one or more hollow spaces 24 enhances the sealing of seams, including openings or interfaces between the pipe coupler 50 components (e.g., flanges, sleeves, clamping ring). In some aspects, the liquid that may pressurize the one or more hollow spaces 24 may be the same liquid flowing through the pipe segments 60-1, 60-2, such that internal line pressure contributes directly to the sealing performance. This arrangement allows the rubberized gasket 20 to provide a self-energizing seal that becomes tighter as internal fluid pressure increases.

Each pipe segment to be coupled by the pipe coupler 50 may be fused to a respective hub. For instance, the first pipe segment 60-1 may be fused to the first tubular hub 10-1 and the second pipe segment 60-2 may be fused to the second tubular hub 10-2. A pipe segment may be secured to the respective tubular hub 10-1, 10-2 by utilizing an acceptable fusion method, such as butt fusion, electrofusion, socket welding, laser welding, ultrasonic welding, or friction welding. In butt fusion, the adjoining (e.g., end) surfaces of the hub and the pipe may be heated until softened and then brought together under controlled force along the longitudinal axis. As the fused interface cools, a continuous joint may be formed that integrates the hub and the pipe segment. In electrofusion, the hub may include embedded heating elements that are electrically energized, producing localized heat at the interface between an interior surface of the hub and an exterior surface of the pipe segment. This heating may soften the interfaced materials, allowing them to fuse together without the need for external heating equipment.

In socket welding, both an interior surface of the hub and an exterior surface of the pipe segment may be heated before the pipe segment is inserted into a socket-shaped cavity contained in the hub. As the materials cool and solidify, overlapping surfaces fuse together to produce a sealed joint. In ultrasonic welding, high-frequency vibrations may be applied at the interface between surfaces of the hub and the pipe segment, generating localized heat through friction to soften the materials. These softened materials may fuse under applied pressure, creating a precise and rapid joint therebetween. In friction welding, the hub and pipe segment are pressed together axially while one component rotates relative to the other. The thus generated frictional heat may soften the materials at the interface, and once the rotation ceases, the pressure is maintained until cooling completes the fusion process. Depending on requirements, one or more selected fusion methods may be used to fuse the hub and the pipe segment along an overlapping length, or it may butt-fuse the hub face directly to the pipe segment. Each approach ensures a strong and fluid-tight connection suitable for structural and operational needs of the pipeline.

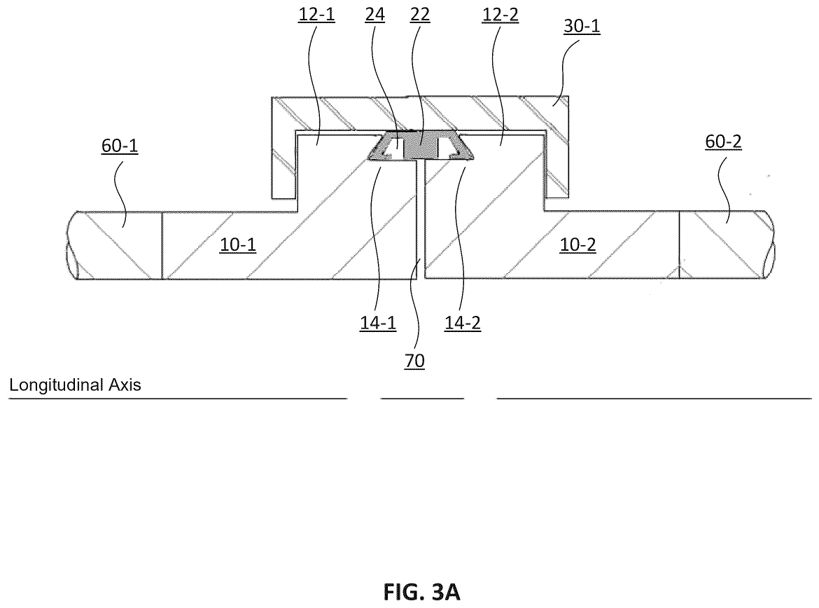

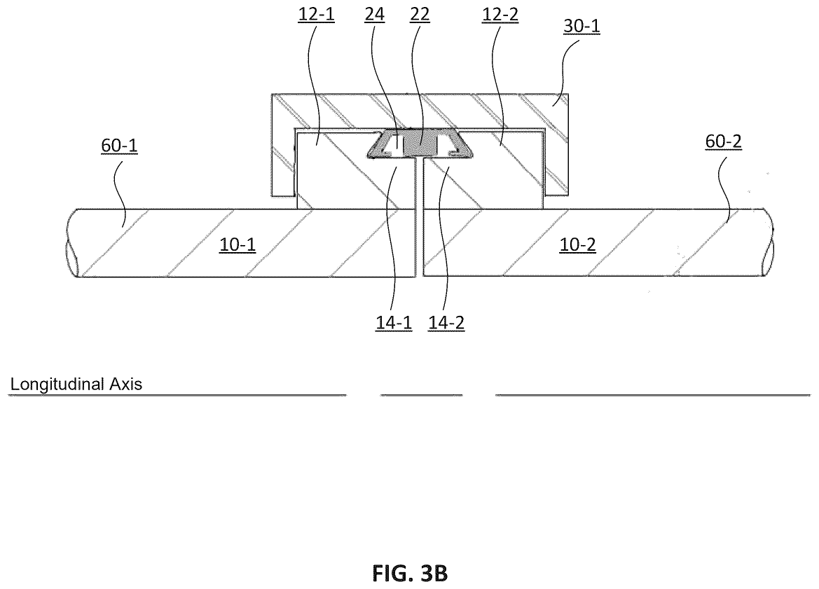

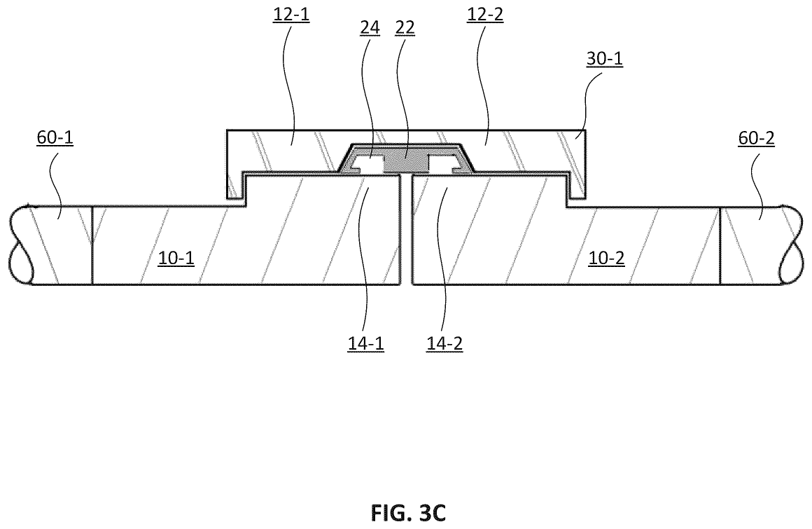

The pipe coupler may also include the clamping ring 30 that is configured to be placed such that the clamping ring 30 annularly extends to cover the first flange 12-1 and the second flange 12-2. Once fastened using the nut/bolts 40, the clamping ring 30 applies compressive forces to the flanges 12-1, 12-2 and/or the rubberized gasket 20, thereby tightly holding the hubs in the mirrored arrangement to form a fluid-tight seal. Various configurations related to the clamping ring covering the flanges are described below with reference to FIGS. 3A-3C.

In some aspects, because the clamping ring 30 is also made of plastic, the amount of height of the flanges (e.g., flange height) can be increased to enable the clamping ring to cover a larger surface area of the flanges, thereby enabling a more robust and reliable seal, without damaging the plastic components (e.g., hubs, clamping ring) of the pipe coupler 50 and/or the plastic pipe segments 60-1, 60-2. For this reason, it is critical to maximize the height of the flanges. As discussed elsewhere herein, this may be accomplished by calculating the flange height based at least in part on the diameter of the pipe segments 60-1, 60-2.

As indicated above, FIGS. 1 and 2 are provided as an example. Other examples may differ from what is described with regard to FIGS. 1 and 2.

FIGS. 3A-3C are illustrations of example configurations 300 associated with pipe coupling configurations, according to various aspects of the present disclosure. These configurations 300 represent the aspects discussed above with respect to FIGS. 1 and 2. FIG. 3A shows a cross-sectional view of a top portion of a pipe coupling. In the configuration shown in FIG. 3A, pipe segment 60-1 is butt fused to an end of tubular hub 10-1, which includes flange 12-1 and sleeve 14-1. Similarly, pipe segment 60-2 is butt fused to an end of tubular hub 10-2, which includes flange 12-2 and sleeve 14-2. The tubular hubs 10-1, 10-2 include a flange height of h inches and are separated in a mirrored arrangement by a predesigned gap 70. An area formed between flange 12-1 and flange 12-2 accepts an annular rubberized gasket 20 such that a first portion of the rubberized gasket 20 rests on sleeve 14-1 and a second portion of the rubberized gasket 20 rests on sleeve 14-2. In some aspects, the rubberized gasket 20 includes a protrusion 22 and hollow spaces 24. In the configuration shown in FIG. 3A, the protrusion 22 extends to physically contact each of the sleeves 14-1, 14-2 such as to physically contact (e.g., touch) and wholly cover the predesigned gap 70. In this way, the protrusion 22 may assist in blocking a liquid being transported through the pipe segments 60-1, 60-2 from escaping (e.g., leaking) in and around seams where the rubberized gasket 20 contacts the flanges 12-1, 12-2 and/or the sleeves 14-1, 14-2. For additional mitigation against leaking, liquid entering the hollow spaces 24 may pressurize the rubberized gasket 20, as discussed elsewhere herein. Finally, a clamping ring 30 extends to cover the flanges 12-1, 12-2 to apply compressive forces thereto, thereby holding the tubular hubs 10-1, 10-2 in the mirrored arrangement to form a fluid-tight seal. In some aspects, the flange height h is determined based at least in part on a diameter of the pipe segments 60-1, 60-2, and may be maximized to enable the clamping ring 30 to cover a larger surface area of the flanges 12-1, 12-2, thereby enabling a more robust and reliable seal, without damaging the pipe coupler or the pipe segments 60-1, 60-2, as discussed elsewhere herein.

The configuration shown in FIG. 3B is similar to the configuration shown in FIG. 3A, with a difference in that pipe segment 60-1 is fused lengthwise along the longitudinal axis to a horizontal surface of tubular hub 10-1 and, similarly, pipe segment 60-2 is fused lengthwise along the longitudinal axis to a horizontal surface of tubular hub 10-2.

The configuration shown in FIG. 3C is similar to the configurations shown in FIGS. 3A and 3B, with a difference in that flange 12-1 is integral with sleeve 14-1 and that flange 12-2 is integral with sleeve 14-2. The area to receive the rubberized gasket 20 is provided in the clamping ring 30.

It will be appreciated that one or more aspects shown in any one of FIGS. 3A, 3B, and 3C is/are compatible with and implementable with one or more aspects shown in the other of FIGS. 3A, 3B, and 3C. Further, it will be appreciated that a diameter of pipe segment 60-1 may be different from a diameter of pipe segment 60-2, and that tubular hubs 10-1, 10-2 may respectively be sized accordingly.

In this way, by utilizing a pipe coupler made of plastic to couple pipe segments made of plastic provides several advantages, as discussed in several instances herein.

As indicated above, FIGS. 3A-3C are provided as an example. Other examples may differ from what is described with regard to FIGS. 3A-3C.

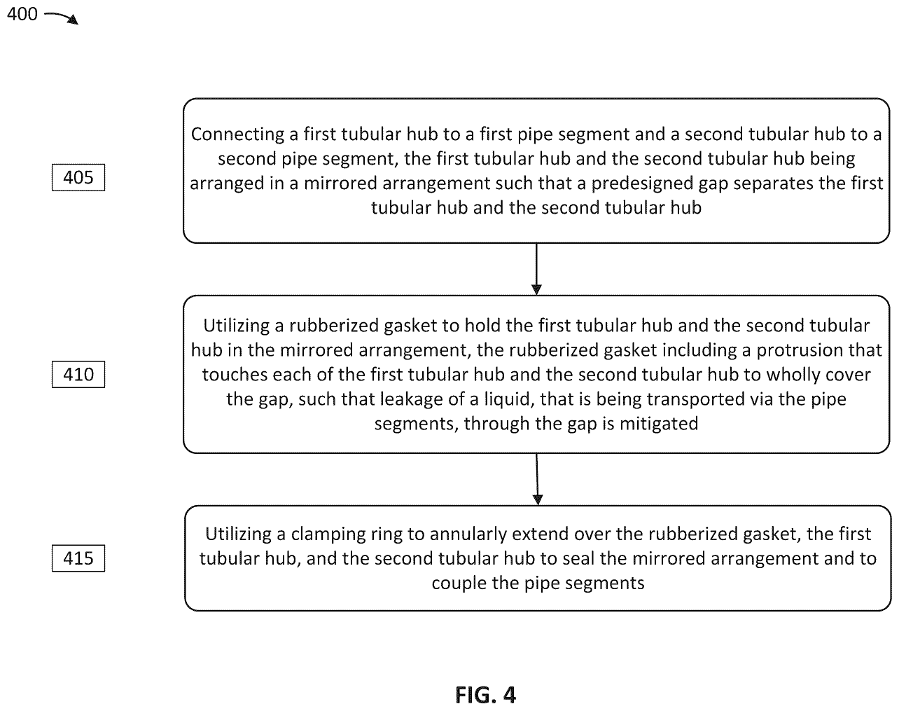

FIG. 4 is an illustration of an example process 400 associated with pipe coupling configurations, according to various aspects of the present disclosure.

As shown by reference numeral 405, process 400 may include connecting a first tubular hub to a first pipe segment and a second tubular hub to a second pipe segment, the first tubular hub and the second tubular hub being arranged in a mirrored arrangement such that a predesigned gap separates the first tubular hub and the second tubular hub. For instance, pipe segments may be secured to respective tubular hubs by utilizing an acceptable fusion method, such as butt fusion, electrofusion, socket welding, laser welding, ultrasonic welding, or friction welding, as discussed elsewhere herein.

As shown by reference numeral 410, process 400 may include utilizing a rubberized gasket to hold the first tubular hub and the second tubular hub in the mirrored arrangement, the rubberized gasket including a protrusion that touches each of the first tubular hub and the second tubular hub to wholly cover the gap, such that leakage of a liquid, that is being transported via the pipe segments, through the gap is mitigated. For instance, the rubberized gasket may hold the first tubular hub and the second tubular hub in the mirrored arrangement, the rubberized gasket including a protrusion that touches each of the first tubular hub and the second tubular hub to wholly cover the gap to prevent leakage of the liquid being transported, as discussed elsewhere herein.

As shown by reference numeral 415, process 400 may include utilizing a clamping ring to annularly extend over the rubberized gasket, the first tubular hub, and the second tubular hub to seal the mirrored arrangement and to couple the pipe segments. For instance, the clamping ring may annularly extend over the rubberized gasket, the first tubular hub, and the second tubular hub to seal the mirrored arrangement and to couple the pipe segments, as discussed elsewhere herein.

Process 400 may include additional aspects, such as any single aspect or any combination of aspects described below and/or in connection with one or more other processes described elsewhere herein.

In a first aspect, in process 400, the first tubular hub, the second tubular hub, and the clamping ring are made of plastic.

In a second aspect, alone or in combination with the first aspect, in process 400, the first tubular hub includes a first flange and a first sleeve, and the second tubular hub includes a second flange and a second sleeve, wherein the protrusion touches the first sleeve and the second sleeve.

In a third aspect, alone or in combination with the first through second aspects, in process 400, the first tubular hub includes a flange having a height that is determined based at least in part on a diameter of the plastic pipe segments.

In a fourth aspect, alone or in combination with the first through third aspects, in process 400, the first tubular hub includes a first flange having a first height that is determined based at least in part on a permissible stress contact value associated with the first tubular hub.

In a fifth aspect, alone or in combination with the first through fourth aspects, in process 400, the rubberized gasket includes one or more hollow spaces such that the rubberized gasket expands when pressurized by the liquid, thereby sealing a seam in the mirrored arrangement.

In a sixth aspect, alone or in combination with the first through fifth aspects, in process 400, a first plastic pipe segment is fused to the first tubular hub and a second plastic pipe segment is fused to the second tubular hub.

In a seventh aspect, alone or in combination with the first through sixth aspects, in process 400, the first tubular hub, the second tubular hub, and the clamping ring expand or contract at a similar rate as the plastic pipe segments.

In an eighth aspect, alone or in combination with the first through seventh aspects, in process 400, the first tubular hub and the second tubular form an area to accommodate the rubberized gasket in the pipe coupler.

In a ninth aspect, alone or in combination with the first through eighth aspects, in process 400, the clamping ring provides an area to accommodate the rubberized gasket in the pipe coupler.

Although FIG. 4 shows example blocks of the process, in some aspects, the process may include additional blocks, fewer blocks, different blocks, or differently arranged blocks than those depicted in FIG. 4. Additionally, or alternatively, two or more of the blocks of the process may be performed in parallel.

As indicated above, FIG. 4 is provided as an example. Other examples may differ from what is described with regard to FIG. 4.

Persons of ordinary skill in the art will appreciate that the aspects encompassed by the present disclosure are not limited to the particular exemplary aspects described herein. In that regard, although illustrative aspects have been shown and described, a wide range of modification, change, and substitution is contemplated in the foregoing disclosure. It is understood that such variations may be made to the aspects without departing from the scope of the present disclosure. Accordingly, it is appropriate that the appended claims be construed broadly and in a manner consistent with the present disclosure.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

As used herein, satisfying a threshold may, depending on the context, refer to a value being greater than the threshold, greater than or equal to the threshold, less than the threshold, less than or equal to the threshold, equal to the threshold, or not equal to the threshold, among other examples, or combinations thereof.

Even though particular combinations of features are recited in the claims or disclosed in the specification, these combinations are not intended to limit the disclosure of various aspects. In fact, many of these features may be combined in ways not specifically recited in the claims or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A plastic pipe coupler system configured to couple plastic pipe segments, the pipe coupler system comprising:
a first tubular hub connected to a first pipe segment and a second tubular hub connected to a second pipe segment, the first tubular hub and the second tubular hub being arranged in a mirrored arrangement such that a predesigned gap separates the first tubular hub and the second tubular hub;
a rubberized gasket configured to hold the first tubular hub and the second tubular hub in the mirrored arrangement, the rubberized gasket including a protrusion that touches each of the first tubular hub and the second tubular hub to wholly cover the gap, such that leakage of a liquid, that is being transported via the pipe segments, through the gap is mitigated; and
a clamping ring configured to annularly extend over the rubberized gasket, the first tubular hub, and the second tubular hub to seal the mirrored arrangement and to couple the pipe segments

2. The plastic pipe coupler system of claim 1, wherein the first tubular hub, the second tubular hub, and the clamping ring are made of plastic.

3. The plastic pipe coupler system of claim 1, wherein the first tubular hub includes a first flange and a first sleeve, and the second tubular hub includes a second flange and a second sleeve, wherein the protrusion touches the first sleeve and the second sleeve.

4. The plastic pipe coupler system of claim 1, wherein the first tubular hub includes a flange having a height that is determined based at least in part on a diameter of the plastic pipe segments.

5. The plastic pipe coupler system of claim 1, wherein the first tubular hub includes a first flange having a first height that is determined based at least in part on a permissible stress contact value associated with the first tubular hub.

6. The plastic pipe coupler system of claim 1, wherein the rubberized gasket includes one or more hollow spaces such that the rubberized gasket expands when pressurized by the liquid, thereby sealing a seam in the mirrored arrangement.

7. The plastic pipe coupler system of claim 1, wherein a first plastic pipe segment is fused to the first tubular hub and a second plastic pipe segment is fused to the second tubular hub.

8. The plastic pipe coupler system of claim 1, wherein the first tubular hub, the second tubular hub, and the clamping ring expand or contract thermally at a similar rate as the plastic pipe segments.

9. The plastic pipe coupler system of claim 1, wherein the first tubular hub and the second tubular form an area to accommodate the rubberized gasket in the pipe coupler.

10. The plastic pipe coupler system of claim 1, wherein the clamping ring provides an area to accommodate the rubberized gasket in the pipe coupler.

11. A method for utilizing a pipe coupler to couple plastic pipe segments, the method comprising:
connecting a first tubular hub to a first pipe segment and a second tubular hub to a second pipe segment, the first tubular hub and the second tubular hub being arranged in a mirrored arrangement such that a predesigned gap separates the first tubular hub and the second tubular hub;
utilizing a rubberized gasket to hold the first tubular hub and the second tubular hub in the mirrored arrangement, the rubberized gasket including a protrusion that touches each of the first tubular hub and the second tubular hub to wholly cover the gap, such that leakage of a liquid, that is being transported via the pipe segments, through the gap is mitigated; and
utilizing a clamping ring to annularly extend over the rubberized gasket, the first tubular hub, and the second tubular hub to seal the mirrored arrangement and to couple the pipe segments.

12. The method of claim 11, wherein the first tubular hub, the second tubular hub, and the clamping ring are made of plastic.

13. The method of claim 11, wherein the first tubular hub includes a first flange and a first sleeve, and the second tubular hub includes a second flange and a second sleeve, wherein the protrusion touches the first sleeve and the second sleeve.

14. The method of claim 11, wherein the first tubular hub includes a flange having a height that is determined based at least in part on a diameter of the plastic pipe segments.

15. The method of claim 11, wherein the first tubular hub includes a first flange having a first height that is determined based at least in part on a permissible stress contact value associated with the first tubular hub.

16. The method of claim 11, wherein the rubberized gasket includes one or more hollow spaces such that the rubberized gasket expands when pressurized by the liquid, thereby sealing a seam in the mirrored arrangement.

17. The method of claim 11, wherein a first plastic pipe segment is fused to the first tubular hub and a second plastic pipe segment is fused to the second tubular hub.

18. The method of claim 11, wherein the first tubular hub, the second tubular hub, and the clamping ring expand or contract thermally at a similar rate as the plastic pipe segments.

19. The method of claim 11, wherein the first tubular hub and the second tubular form an area to accommodate the rubberized gasket in the pipe coupler.

20. The method of claim 11, wherein the clamping ring provides an area to accommodate the rubberized gasket in the pipe coupler.
